(19) United States
(12) Patent Application Publication
(10) Pub. No.: US 2002/0159654 A1
(43) Pub. Date: Oct. 31, 2002

(54) Method for processing an image of a concrete construction

(75) Inventor: Hiroshi Koide, Kawasaki-shi (JP)

Correspondence Address: OLIFF & BERRIDGE, PLC, P.O. BOX 19928, ALEXANDRIA, VA, 22320, US

(73) Assignee: NIKON CORPORATION, Tokyo (JP)

(21) Appl. No.: 10/127,560

(22) Filed: Apr. 23, 2002

(30) Foreign Application Priority Data
Apr. 25, 2001 (JP) 2001-127245

(51) Int. Cl. G06K 9/36

(52) U.S. Cl. 382/284

(57) ABSTRACT

An object of the present invention is to provide a method to correct distortion in a photographic image of a concrete construction. A concrete construction is constructed by pouring concrete into spaces formed by a plurality of moldboards, whereby the removed moldboard left the prints thereof on the surface of the concrete construction. The present invention exploits these features of a concrete construction. A method according to present invention comprises the steps of determining positions of the print of vertexes of the moldboards in the image and modifying the image on the basis of the positions of the print of vertexes so as to remove distortion of the image.

This application is on the basis of and claims priority of Japan Patent Application No. 2001-127245 filed on Apr. 25, 2001, the contents being incorporated by reference.

### BACKGROUND OF THE INVENTION

1. Field of the Invention

The invention relates to a method for processing photographic images, and more particularly, to a method for correcting distortion in a photographic image to combine a plurality of the images into a single image.

2. Description of the Related Art

There has been a technique to capture images by a digital still camera and analyze the images in order to inspect cracks in a shield tunnel. Instead of using a digital still camera, a digital camcorder is also, used. In either case, ideally, it is preferable that a single wide image should cover a tunnel wall for a given distance in the longitudinal direction of the tunnel.

However, it is difficult to capture a single image covering the given distant tunnel wall because a single image does not have enough resolution to analyze a crack with a sufficient accuracy. Therefore, to obtain an image covering the given distant tunnel wall in the longitudinal direction, it is necessary to capture a plurality of sequential images in the longitudinal direction and combine them into a single image.

In this case, there is a problem with distortion of an image. This distortion is caused by the following two causes:

1. In a construction such as a shield tunnel, since a tunnel wall forms a curved surface, an image of the wall surface is necessarily distorted.

2. Generally, a distant object and an inclined plane to a camera are photographed in a smaller size.

This distortion appears in FIGS. 1 and 2. FIGS. 1 and 2 illustrate images of wall surfaces in a shield tunnel, which are captured by a digital camera. FIG. 1 shows a wall surface of one side of the shield tunnel, which is captured from the other side of the tunnel. In FIG. 1, the top of the image corresponds to the top of the tunnel, the bottom of the image corresponds to the bottom of the tunnel, and the horizontal direction of the image corresponds to the longitudinal direction of the tunnel. FIG. 2 shows an upper wall surface of the shield tunnel, which is an image viewed from one side of the tunnel to the upper wall surface of the tunnel. An area located a little at the right side of a middle of the image corresponds to the top wall surface area of the tunnel. A left/right area subsequent to the top wall surface corresponds to a left/right side part of the tunnel wall, and a left/right end of the image corresponds to the lowest part of the wall. And vertical direction of the image corresponds to the longitudinal direction of the tunnel.

FIG. 1 illustrates many lines marked by moldboards. Lines 1, 2, and 3 are moldboard lines that run in the cross-sectional direction of the shield tunnel Many lines 4 are moldboard lines that run in the longitudinal direction of the tunnel. To construct a shield tunnel, many moldboards are built to form an entire mold of a tunnel wall, and then concrete is poured into a space between rocks and the moldboards. After concrete becomes solid, slits between moldboards remains as lines such as 1, 2, 3, and 4 on the surface of the tunnel wall.

In FIG. 1, cross-sectional-direction lines 1 and 3 are formed in curved shape because of the above-described cause 1. However, a desired image is an image in which lines 1 and 3 are straight lines. Cross-sectional-direction line 2 is formed in an almost straight shape because an optical axis of a camera lens is set in front of the line 2. A distance between two lines 4 becomes smaller as a position of line 4 approaches the bottom of the tunnel. However, a desired image is an image in which each distance between two lines 4 is spaced in a constant interval.

In FIG. 2, lines 1 and 2 are cross-sectional-direction lines, and lines 4 are longitudinal-direction lines. Lines 5 are electric wires on the ceiling of the tunnel. Cross-sectional-direction lines 1 and 2 are formed in a curved shape. A distance between two longitudinal-direction lines 4 becomes smaller as a position of line 4 approaches the right end of the image because of the above-described cause 2.

To inspect cracks on a tunnel wall accurately, the most necessary image is a development of the tunnel wall surface. Using a development of the tunnel wall surface, an inspector can see a plane view of a wall surface instead of a curved wall surface. This development should be a continues image for a given distance in the longitudinal direction. If an inspector captures a large image of a crack, a field of view will become narrower. In order to capture an image of a wider area, he needs to capture plural images to cover the area. And he needs to combine the plural images to make a single image from them, but it is difficult to make a single accurate image. To make an accurate image, he needs to capture images including a common standard object in them, which is used as a standard for combining images. But this standard object looks different in each image because each image is captured from a different direction. Therefore, this standard object cannot serve as a standard. If it is used as a standard, it will cause a problem that plural images cannot be combined accurately.

### SUMMARY OF THE INVENTION

An object of the present invention is to provide a method to correct distortion in a photographic image of a concrete construction, which has been caused by a position of a camera and a curved surface of the object. Another object of the present invention is to provide a method to combine a plurality of images into a single image with the distortion of each image corrected by the above method.

A concrete construction is constructed by pouring concrete into spaces formed by moldboards. The removed moldboards have left the print thereof on the surface of the concrete construction. Generally, a size of a moldboard is known and the same size of a moldboard is used. The present invention exploits these features of a concrete construction.

According to one aspect of the present invention to achieve the objects described above, a method for processing an image is applied to a concrete construction that has been constructed by using a plurality of moldboards having vertexes. The moldboards are arranged so that a vertex of a moldboard is located on a predetermined position relative to a contiguous moldboard, whereby the removed moldboards have left the print thereof on the surface of the concrete construction. The method comprises the steps of determining positions of the print of vertexes of the moldboards in the image and modifying the image on the basis of the positions of the print of vertexes so as to remove distortion of the image.

The modification of the image to remove distortion of the image is executed on the basis of the positions of the vertexes of the moldboards in the image. Accordingly any additional reference is not needed for removing the distortion of the image.

According to another aspect of the present invention, the modifying step includes a step of selecting a plurality of areas of the image corresponding to the print of moldboards on the basis of the positions of the print of vertexes, a step of correcting each area of the image and a step of combining the corrected areas of the image into a single image.

By means of these steps, the distortion of the image can be corrected accurately.

According to another aspect of the present invention, the correcting step includes a step of determining parameters of a formula to be used for correcting one of the selected areas of the image and a step of correcting with the parameter a part of the image other then the selected areas. Thus, the part of the image other then the selected areas can also be corrected.

The present invention in advantageously applicable to a concrete construction having a curved surface in at least a part thereof, with shapes and sizes of the moldboards known. In this case, the correcting step transforms the shape of the areas of the image on the basis of the information of the shapes of the moldboards and changes the sizes of the transformed areas of the image on the basis of the information of the sizes of the moldboards.

In one of the preferred embodiment of the invention, the moldboards are rectangles of the same size with the vertexes of contiguous moldboards arranged along a line.

In another preferred embodiment of the invention, the correcting step corrects the areas of the image by using pseudo-affine transformation.

In a construction of a concrete construction, for example a shield tunnel, rectangular moldboards of the same size are most used and the vertexes of contiguous moldboards are arranged along a line. One group of moldboard lines is straight and the other group of moldboard lines that cross the former group is curved. Pseudo-affine transformation is suitable for correcting the image of the concrete construction, in which a distortion would be caused by the structure of the construction described above.

According to another aspect of the present invention, an image processing method is applied to correct distortion of a photographic image of a concrete construction having a curved surface in at least a part thereof, that is constructed by using a plurality of moldboards. The method transforms images of lines of the moldboards so that the transformed lines are coincided with lines of moldboards that are arranged in a plane so as to adjoin to each side.

This transformation of lines may be applicable to each moldboard or a combination of a plurality of moldboards. The transformation for each moldboard should have higher accuracy. Thus, an image of lines developed in a plane can be obtained.

In the above description, although “the transformed lines are coincide with lines of moldboards that are arranged in a plane so as to adjoin to each side”, the invention is not limited to this. The transformed moldboard may have an arbitrary aspect ratio.

According to another aspect of the present invention, a plurality of the transformed images having a common moldboard line are combined into a single image by using the common moldboard line as a reference line.

Processing an image in such a way as described above, a user can have a accurate development of the image, thereby having a common moldboard line among a plurality of processed images. By combining the plural processed images by using a common moldboard line as a reference line, a user can have an accurate combined image.

Other feature and advantages according to the invention will be readily understood from the detailed description of the preferred embodiments in conjunction with the accompanying drawings.

### BRIEF DESCRIPTION OF THE DRAWINGS

FIG. 1 is a schematic view of an image illustrating a wall surface of a shield tunnel, which is viewed from one side of the tunnel wall to a wall surface of the other side, in accordance with an embodiment of the present invention.

FIG. 2 is a schematic view of an image illustrating another wall surface of the shield tunnel that is viewed from one side of the tunnel wall to the upper side of the tunnel.

FIG. 3 is a flowchart illustrating a method of image processing in accordance with an embodiment of the present invention.

FIG. 4 is a schematic view illustrating an image that is processed from the image in FIG. 1 by using a method of the present invention.

FIG. 5 is a schematic view illustrating an image that is processed from the image in FIG. 2 by using a method of the present invention.

FIG. 6 is a schematic view of an image illustrating a wall surface of another shield tunnel, which is viewed from one side of the tunnel wall to a wall surface of the other side.

### DETAILED DESCRIPTION OF THE PREFERRED EMBODIMENTS

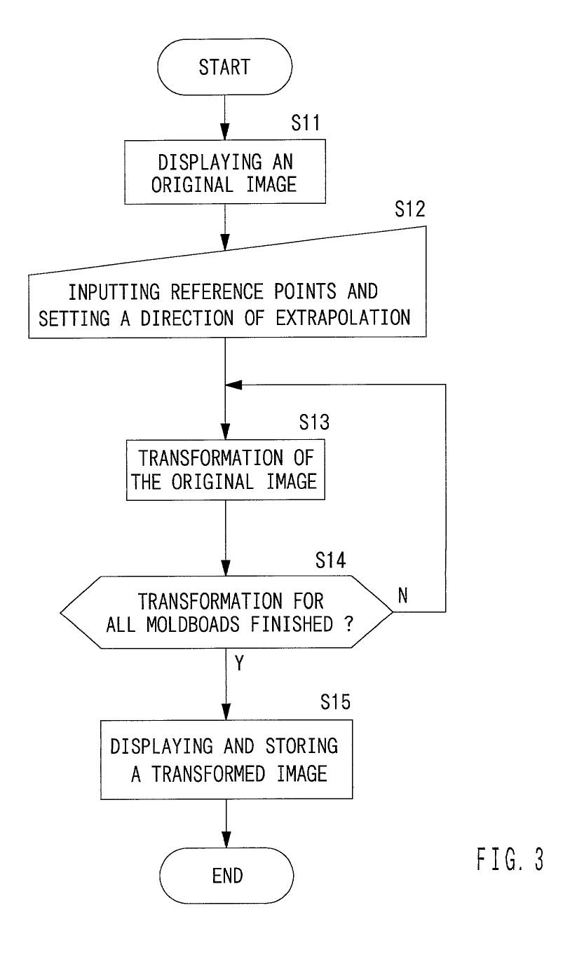

An embodiment of the present invention will be described below with reference to drawings. FIG. 3 is a flow chart illustrating an image processing method in accordance with an embodiment of the present invention. In step S11 of FIG. 3, an original image captured by a camera is displayed on a screen of a man-machine interface device.

In step 12, a user inputs reference positions of moldboard lines by using a mouse pointer on the screen. At the same time, he sets a direction of extrapolation on the screen (vertical or horizontal). If several size moldboards are used, these sizes must be input. In step S13, transforming the original image to a development is instructed to a computer. The transformation is proceeded for each moldboard by a predetermined method over a specified extrapolation area and is continued until the transformation of all moldboards has been finished.

In step S14, it is determined whether transformation of all moldboards is finished. If the transformation is not finished yet, the process returns to step S13 and transformation of a new moldboard is executed.

When the transformation of all of moldboards is finished, a transformed image is displayed on the screen of the man-machine interface device and data is stored in memory in step S15.

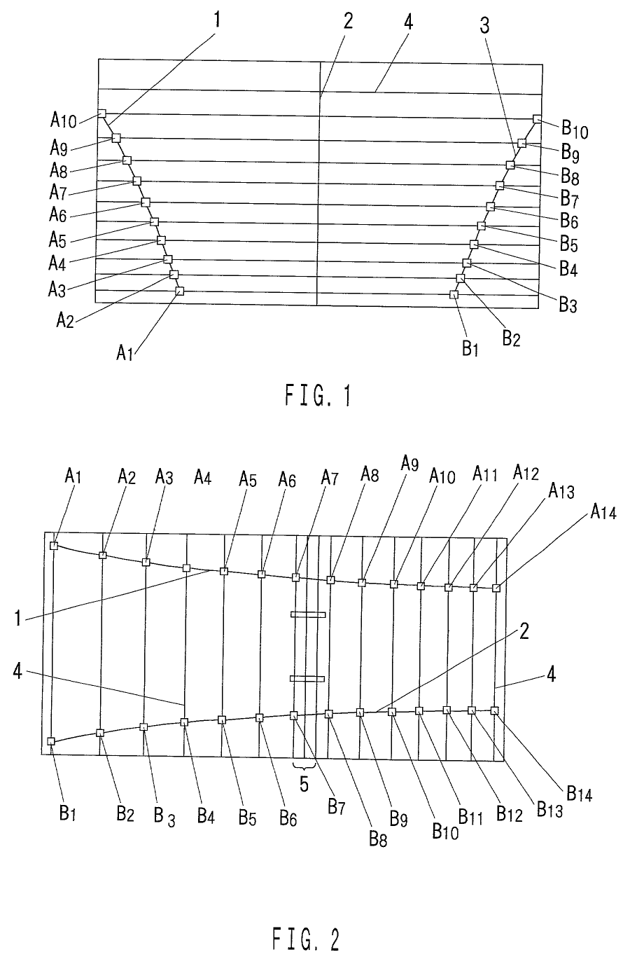

The transformation is performed as follows. First, an original image as shown in FIG. 1 is displayed on the screen. This image is one of plural images that cover a tunnel wall area to be inspected. This image includes cross-sectional-direction lines 1, 2, and 3, and many longitudinal direction lines 4 of moldboards. Let an intersection point of line 1 and line 4 be Ai. Likewise, let an intersection point of line 3 and line 4 be Bi, as shown in FIG. 1. A position of Ai is represented as coordinates (xAi, yAi), and a position of Bi is represented as coordinates (xBi, yBi).

Positions of points from A1 to A10 and from B1 to B10 are input by a mouse pointer. Extrapolation in the longitudinal direction is instructed. Letters Ai and Bi, having the same subscript i, are located on the same line 4. The number of points on line 1 are the same as those on line 3. After transformation is executed, let a point corresponding to Ai be Ai′ (xAi′, yAi′), and let a point corresponding to Bi be Bi′ (xBi′, yBi′).

For the purpose of simplicity, let all moldboards be the same size rectangles. First, points A1 and B1 are selected as reference points and their positions are kept unchanged in later operations. Then, transformation is executed so that point A2/B2 is positioned right above A1/B1. That is, the following transformation is performed.

A1′=A1, B1′=B1,

(xA2′, yA2′)=(xA1, yA2)

(xB2′, yB2′)=(xB1, yB2)

Commonly, the following equation holds.

yA2−yA1=yB2−yB1

If this equation does not hold, the following equation is used.

yB2′=yB1+yA2−yA1

The transformation is performed by using pseudo-affine transformation. When a point (x, y) before transformation corresponds to a point (u, v) after transformation, the transformation is performed so that the following equations hold.

u=axy+bx+cy+d (1)

v=exy+fx+gy+h (2)

Letters a-h are constants.

Coordinates of four points A1, A2, B1, and B2 are determined. Coordinates of four points A1′, A2′, B1′, and B2′ are also determined. Then, values of a-h are determined by solving equations (1) and (2). After values of a-h are determined, an area enclosed by four points A1, A2, B1, and B2 is transformed by using equations (1) and (2). At the same time, areas on the right and left side of this area are also transformed by using equations (1) and (2).

Next, in the same way, an area enclosed by points A2, A3, B2, and B3 is transformed, and areas on the right and left side of this area are also transformed. In transformation of an area enclosed by points A2, A3, B2, and B3, the transformation is executed so that point A3′ is positioned right above point A2′, and point B3′ is positioned right above point B2′. At the same time, the transformation is executed so that a distance between points A1′ and A2′ is equal to a distance between points A2′ and A3′ and this distance is equal to a distance between points B2′ and B3′. (A distance between points A1′ and A2′ has been already made equal to a distance between points B1′ and B2′ by the previous transformation.)

When yA2′−yA1′=Δ,

(xA3′, yA3′)=(xA1′, yA2′+Δ)

(xB3′, yB3′)=(xB1′, yB2′+Δ)

And, for these four points, constants a-h are determined by solving equations (1) and (2). Using these constants, an area enclosed by points A2, A3. B2, and B3 is transformed, and in the same way, areas on the right and left side of the area are transformed.

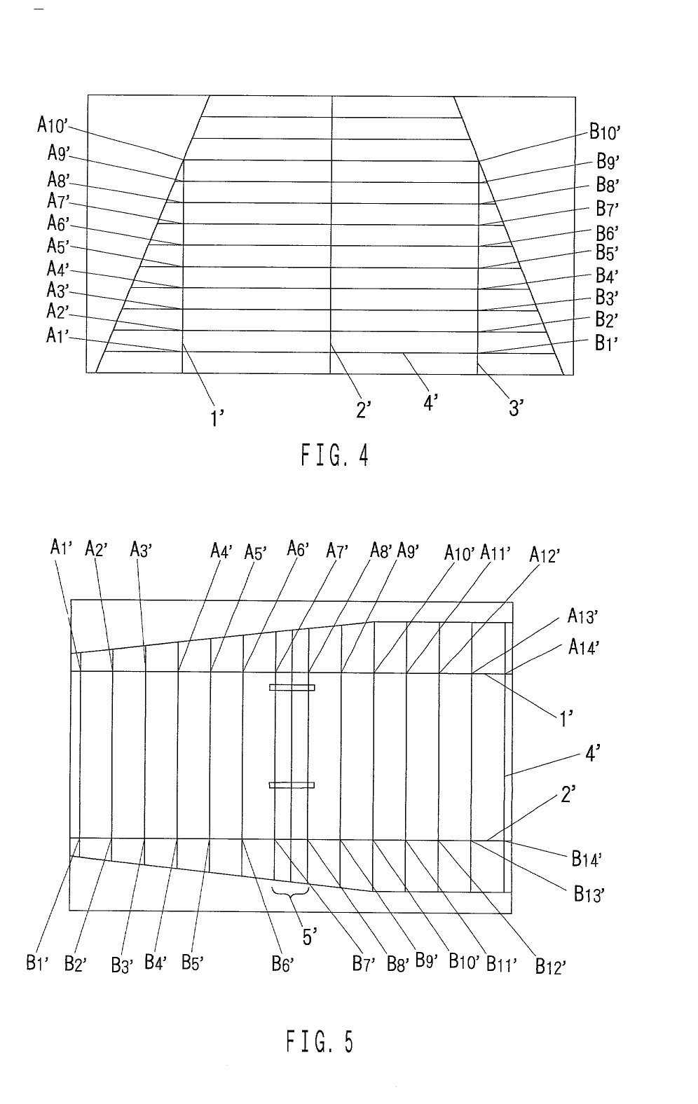

Likewise, transformation of every area enclosed by four corner points of moldboards is performed (actually, four corner points of a combination of two contiguous moldboards are used). In this transformation, coordinates of the four corner points are determined so that each point is positioned on a vertical line and each distance between two points is spaced equally. Last, an area enclosed by A9, A10, B9, and B10 is transformed. At the same time, transforming range is extended to other range, i.e., right, left, upper, and oblique upper sides of the area enclosed by A9, A10, B9, and B10. And transformation is performed also by the pseudo-affine transformation using the same constants. Thus, transformation has been performed, resulting in an image as shown in FIG. 4, which is a development of the image of FIG. 1.

In the above example, it is assumed to be yA2′=yA2=yB2′=yB2. Instead, if it is assumed that yA2′=k·(yA2−yA1)+yA1 and yB2′=k·(yB2−yB1)+yB1 (k is a constant), we can set an arbitrary aspect ratio of a subject. In this case, the above-described value of Δ is set to k(yA2−yA1)=k(yB2−yB1). For an image as shown in FIG. 2, the pseudo-affine transformation is performed as well as that for the image of FIG. 1, resulting in a development of the image of FIG. 2. At this time, x is replaced with y each other in the above-described equations. The resulting development is shown in FIG. 5.

In accordance with the embodiment of the present invention described above, the present invention can correct distortion of an image of a concrete construction, which is caused by difference in photographing positions and a curved surface of a subject, and then the present invention can make a development of the image. In accordance with an embodiment of the present invention described hereinabove, y-coordinate of the next point is determined by adding Δ to y-coordinate of the current point under the assumption that a width of each moldboard is the same. However, when moldboards having different widths are used, each corresponding value for each moldboard must be used instead of adding Δ to the current y-coordinate.

Furthermore, when a moldboard is a trapezoid or a parallelogram, transformation can be appropriately done by performing the following operations. That is, positions of four vertexes are input to the program by using the above-mentioned method, and a desired size of a trapezoid or a parallelogram after transformation (i.e., a size similar to the original size) is input.

Furthermore, in accordance with an embodiment of the present invention hereinabove, pseudo-affine transformation is used. Although the pseudo-affine transformation is suitable for creating a development of an image of a construction such as a shield tunnel, in some cases, just affine transformation or other transformation method may be used.

Furthermore, transformation is performed by using cross-sectional directional lines 1 and 3, and four vertexes of a combination of two moldboards are used. However, transformation may be performed first by using cross-sectional direction lines 1 and 2, and then by using cross-sectional direction lines 3 and 4. Thus, instead of using four vertexes of a combination of two moldboards, using four vertexes of a moldboard performs accurate transformation.

Furthermore, in accordance with an embodiment of the present invention, transformation is performed by determining positions of Ai and Bi using a mouse pointer. However, transformation may be performed by determining them using image processing. For example, when an original image is displayed on the screen, assume that each start point of cross-sectional direction lines 1 and 3 is located at the same distance from line 2 on longitudinal direction line 4. Likewise, assume that each end point of cross-sectional direction lines 1 and 3 is located at the same distance from line 2 on longitudinal direction line 4. Then, trace lines 1 and 3 from the start point to the end point, thereby shapes of lines 1 and 3 being input to a computer. Then the computer automatically calculates positions of intersection points of line 1(3) and longitudinal line 4 over the traced range.

Specifically, when an image of FIG. 1 is displayed on the screen, cross-sectional direction line 1 is traced from points A1 to A10, and cross-sectional direction line 3 is traced from points B1 to B10. Then, a computer automatically calculates positions of A1 to A10 and B1 to B10. Following this, the previously-described operations are executed.

Furthermore, instead of tracing line 1 and 3, determination of those intersection points may be made by selecting a range of transformation on the screen by the mouse, thereby detecting intersection points.

On the other hand, all intersection points of cross-sectional direction lines and longitudinal direction lines may be detected first, and then selecting a range of transformation may be performed. For example, in FIG. 1, all the intersection points of cross-sectional direction lines 1 and 3 and longitudinal direction lines 4 are first detected being represented in color, among them the points A1, B1, A10, and B10 are specified to select a range of transformation to transform all moldboards in this range. In this case, instead of using all longitudinal direction lines 4, predetermined number of lines 4 may be sipped periodically.

Thus a large image can be created by combining plural images that are transformed from original images, one of which is shown in FIGS. 4 or 5, which are captured for different sequential areas. Specifically, two separate images are combined on the screen by moving one image next to the other fixed image so as to coincide with each corresponding moldboard line. Such manipulation is easily possible by using a commercial image-processing program.

Furthermore, it is also possible to combine images by using a know program of pattern matching, which automatically adjusts positions of two images.

Furthermore, in accordance with an embodiment of the present invention, transformation is performed for an image of a tunnel wall surface that is curved at least in a part thereof. However, the method of the present invention may be used for an image of a plane surface of a concrete construction, and the method is valid for correcting distortion caused by difference in photographing distances and in photographing directions to the plane surface.

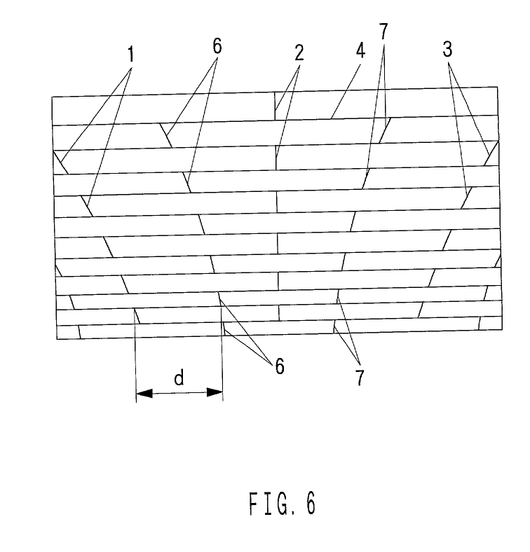

Furthermore, the present invention is applied to an image of moldboards of which vertexes are contagious to vertexes of the next moldboard. However, the present invention may be applied to an image of moldboards that are arranged like a staggered pattern. In this staggered arrangement of the moldboards, if a relative distance between corresponding vertexes of two contagious moldboards is known, the method of the present invention can be used. Specifically, in FIG. 6, which illustrates a shield-tunnel wall surface that forms a staggered pattern of moldboards and of which area corresponds to the area of FIG. 1, if distance d, i.e., the above-described relative distance, is known, the method of the present invention can be used. That is, each moldboard is defined as a unit, on the basis of vertexes of the moldboard, and then distortion in an image is corrected for each of the units. And then corrected images are combined into a single image on the basis of the distance d. Thus distortion of an image having the staggered pattern is corrected. Note that, in FIG. 6, lines 1-4 are lines of moldboards corresponding to the lines of moldboards 1-4 of FIG. 1. Lines 6 and 7 are also lines of moldboards.

Although the present invention has been described above with respect to one embodiment, the invention is not limited to only this embodiment and changes may be made in the embodiment, the scope of which is defined in the claims and their equivalents.

What is claimed is:

1. A method for processing an image of a concrete construction that has been constructed by using a plurality of moldboards having vertexes arranged so that a vertex of a moldboard is located on a predetermined position relative to a contiguous moldboard, whereby the removed moldboards have left the print thereof on the surface of the concrete construction, the method comprising the steps of:
determining positions of the print of vertexes of the moldboards in the image; and
modifying the image on the basis of the positions of the print of vertexes so as to remove distortion of the image.

2. A method according to claim 1, wherein the determining step includes a step of designating positions of the print of vertexes in the image.

3. A method according to claim 1, wherein the determining step includes a step of detecting positions of the print of vertexes by means of image processing.

4. A method according to claim 1 wherein the modifying step includes a step of selecting a plurality of areas of the image corresponding to the print of moldboards on the basis of the positions of the print of vertexes, a step of correcting each area of the image and a step of combining the corrected areas of the image into a single image.

5. A method according to claim 4, wherein the correcting step includes a step of determining parameters of a formula to be used for correcting one of the selected areas of the image and a step of correcting with the parameter a part of the image other then the selected areas.

6. A method according to claim 4, wherein the concrete construction has a curved surface in at least a part thereof, and wherein the shapes and sizes of the moldboards are known, the correcting step transforming the shape of the areas of the image on the basis of the information of the shapes of the moldboards and changing the sizes of the transformed areas of the image on the basis of the information of the sizes of the moldboards.

7. A method according to claim 6, wherein the moldboards are rectangles of the same size with the vertexes of contiguous moldboards arranged along a line.

8. A method according to claim 6, wherein the correcting step corrects the areas of the image by using pseudo-affine transformation.

9. A method according to claim 4, wherein the combining step combines the corrected areas of the image by locating a print of vertex of a moldboard to the predetermined position of the print of contiguous moldboard.

10. A method according to claim 4, wherein the combining step combines the corrected areas of the image on the basis of the position of the print of vertexes of the moldboard.

11. A device for processing an image of a concrete construction that has been constructed by using a plurality of moldboards having vertexes arranged so that a vertex of the moldboard is located on a predetermined position relative to a contiguous moldboard, whereby the removed moldboards have left the prints thereof on the surface of concrete construction, the device comprising:
a finder that determines positions of the print of vertexes of the moldboards in the image; and
a modifier that corrects the image on the basis of the positions of the vertexes so as to remove distortion of the image.

12. A program for processing an image of a concrete construction that is constructed by using a plurality of moldboards arranged so that vertex of the moldboard is located on a predetermined position of relative to a contiguous moldboard, whereby the removed moldboards have left the prints thereof on the surface of the concrete construction, the program comprising the steps of:
determining positions of the print of the vertexes of the moldboards in the image; and
modifying the image on the basis of the positions of the print of vertexes so as to remove distortion of the image.

13. An image processing method for correcting distortion of a photographic image of a concrete construction having a curved surface in at least part thereof, that has been constructed by using a plurality of moldboards, characterized in that the photographic image is transformed so that the print of the moldboards on the curved surface are distorted as if they are printed by moldboards adjoining to each other in a plane.

14. An image processing method according to claim 13, wherein a plurality of transformed images have a common moldboard line, and wherein the plurality of transformed images are combined into a single image by using the common moldboard line as a reference line.
